(19) United States
(12) Patent Application Publication
(10) Pub. No.: US 2009/0136199 A1
(43) Pub. Date: May 28, 2009

(54) PICTURE REPRODUCER

(75) Inventor: Kentaro MATSUMOTO, Saitama (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/276,506

(22) Filed: Nov. 24, 2008

(30) Foreign Application Priority Data
Nov. 26, 2007 (JP) 2007-304383

(51) Int. Cl. H04N 5/91

(52) U.S. Cl. 386/46

(57) ABSTRACT

A picture reproducer has a display, an image-selecting device, an offset-detecting device, and a memory. The display successively displays a plurality of images. The image-selecting device selects a first still image and a second still image from a plurality of images displayed on said display. The offset-detecting device detects the offset between the first still image and the second still image. The memory stores the offset. The offset-detecting device updates the offset stored in said memory every time the offset is detected. The display displays a target still image which is offset from another still image by the updated offset, when the another still image is selected.

### BACKGROUND OF THE INVENTION

1. Field of the Invention

The present invention relates to a picture reproducer which may select desired images from successively displayed images.

2. Description of the Related Art

A conventional picture reproducer comprises a display which successively displays images and a selecting device which selects desired images from images continuously displayed on the display. A user selects desired images by operating the selecting device when he finds desired images during the observation of images displayed on the display.

When images are updated at high frequencies, the user may fail to select a desired image due to his/her response lag in the selecting operation. It is disclosed in Japanese Unexamined Patent Publication (KOKAI) No. 2001-175281 that a conventional picture reproducer selects images in consideration of a user-specific delay time when a user executes the selecting operation such that a user may effectively select desired images.

However, a conventional picture reproducer must measure delay time using test images before usage for each user. This is a cumbersome procedure for the user. A conventional picture reproducer must prepare test images and store them. Moreover, a conventional picture reproducer must measure the delay time again when a user intends to change the delay time.

### SUMMARY OF THE INVENTION

An object of the present invention is to provide a picture reproducer capable of selecting desired images from successively displayed images without performing any special procedure before usage.

The present invention is a picture reproducer having a display, an image-selecting device, an offset-detecting device, and a memory. The display successively displays a plurality of images. The image-selecting device selects a first still image and a second still image from a plurality of images displayed on said display. The offset-detecting device detects the offset between the first still image and the second still image. The memory stores the offset. The offset-detecting device updates the offset stored in said memory every time the offset is detected. The display displays a target still image which is offset from another still image by the updated offset, when the another still image is selected.

### BRIEF DESCRIPTION OF THE DRAWINGS

The objects and advantages of the present invention will be better understood from the following description, with reference to the accompanying drawings in which:

FIG. 1 is a block diagram of a picture reproducer as the first embodiment of the present invention;

FIG. 2 is a schematic view showing the display of a picture reproducer;

FIG. 3 is a schematic view showing the display of a picture reproducer;

FIG. 4 is a flowchart showing the identifying process;

FIG. 5 is a flowchart showing the moving image stopping process;

FIG. 6 is a schematic view showing the display of the picture reproducer in the second embodiment of the present invention; and

FIG. 7 is a schematic view showing the display of the picture reproducer in the third embodiment of the present invention.

### DESCRIPTION OF THE PREFERRED EMBODIMENTS

The first embodiment of the present invention is described below with reference to the drawings.

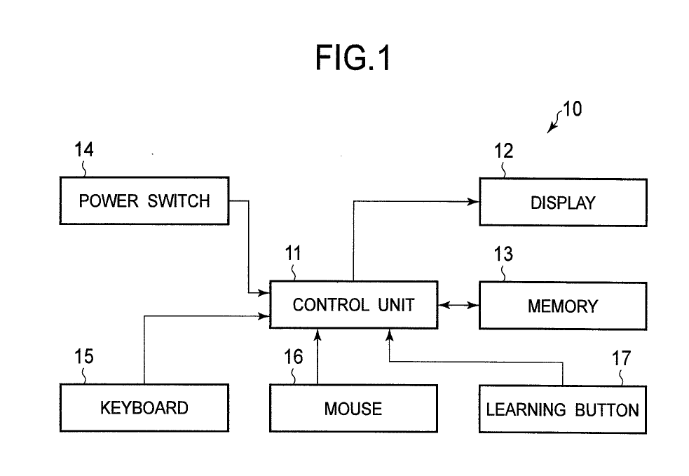

The construction of the picture reproducer is described with reference to FIGS. 1-3.

A picture reproducer 10 mainly comprises a control unit 11, a display 12 which displays moving images, a memory 13 which stores moving images, a power switch 14 controls the power-on/power-off of the picture reproducer 10 and the operating devices 15, 16, and 17 which input data to the control unit 11.

The operating devices 15, 16, and 17 comprise a keyboard 15, a mouse 16, and a learning button 17. The control unit 11 executes an identifying process as described later and identifies the user when the power of the picture reproducer 10 is turned on by operation of the power switch 14. The control unit 11 reads moving images from the memory 13 and displays them.

The display 12 comprises an image area 210 which displays moving images or a still image, an operating area 220 which displays operating buttons, and a scroll bar 230 which indicates the present reproduction position of the moving images. A play/pause button 221 which is used to start or pause the reproduction of the moving image, a stop button 222 which is used to stop the reproduction of the moving image, a first fast-forward button 223 which is used to fast-forward the moving image, a first fast-rewind button 224 which is used to fast-rewind moving image, a next track button 225 which displays the next moving image, and a previous track button 226 which displays the preceding moving image. A user may operate these buttons using the mouse 16, in order to watch moving images.

The scroll bar 230 comprises a progress bar 231 which indicates the complete reproduction time of a moving image, a slider 232 which indicates the current reproduction position of the moving image, and a second fast-forward button 233 and a second fast-rewind button 234 which are provided on the ends of the scroll bar 230. A user may move the slider 232 by dragging the mouse 16, and fast-forward or fast-rewind a moving image by clicking a second fast-forward button 233 and a second fast-rewind button 234 using the mouse 16.

The memory 13 may store a user data base which is constructed by associating user names with their individual time lags ΔTu. A time lag ΔT is the frame number from the moment that a user intends to stop a moving image to the moment that the reproduction of the moving image is actually stopped by operation of the play/pause button 221. The control device 11 retrieves unique time lags ΔTu from the user database.

The control device 11 temporarily stops reproducing a moving image by executing a moving image stopping process which is hereinafter described, when a user operates the play/pause button 221 during the reproduction of a moving image. For example, a moving image may be composed of 30 frames per second. A sequential series of fifteen frames are reduced in size and displayed on the display 12 as fifteen still images when the reproduction is stopped. For example, the offset of each image may be one frame. The fifteen still images are lined in ascending chronological order and connected by arrows in chronological order. The still image 211 centered in the series is not the still image of the frame which was being reproduced at the moment when the user operated the play/pause button 221 during the reproduction of the moving image, but the still image of the frame played with advance ΔT prior to the frame reproduced at the moment when the user actually operated the play/pause button 221. This still image with offset ΔT is the first target image. Thereby, a user is more likely to be presented with the desired still image.

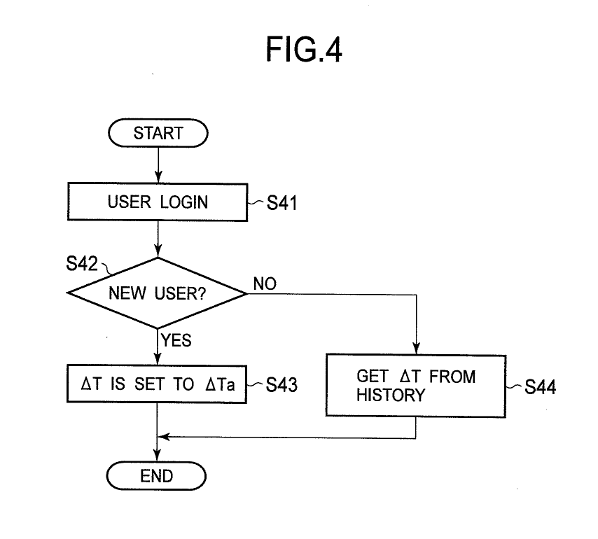

The identifying process is described below with reference to FIG. 4.

The control unit 11 executes the identifying process when the image reproducer 10 is powered on. At step S41, a login process is executed. In the login process, the display 12 displays a login screen which is used by a user to log in to the picture reproducer 10. A user refers to the login screen and inputs his/her user name by keyboard 15 thereby logging into the picture reproducer 10. A password may be required by the picture reproducer 10 to avoid abuse.

In step S42 it is judged whether an inputted user name is registered in the picture reproducer 10 or not. The judgment is executed by the control unit 11 which retrieves the inputted user name from a user database. The user database is stored in the memory 13. In the case that a user name is not stored in the user database, the process proceeds to step S43. In the case that a user name is stored in the user database, a process goes to step S44.

In step S43, the time lag ΔT is substituted by a mean time lag ΔTa which is calculated in advance and stored in the memory 13. The mean time lag ΔTa is mean frame number which is the frame number of a moving image from the moment that an average user desires to stop the moving image to the moment that the moving image is actually stopped.

In step S44, the time lag ΔT is substituted by the unique time lag ΔTu which is unique to the user who logs in to the picture reproducer 10 at the moment. The identifying process is exited after step S43 and S44 end.

In the identification process, a user who has used the picture reproducer 10 before may use his/her unique time lag ΔTu without measuring the time lag ΔT again.

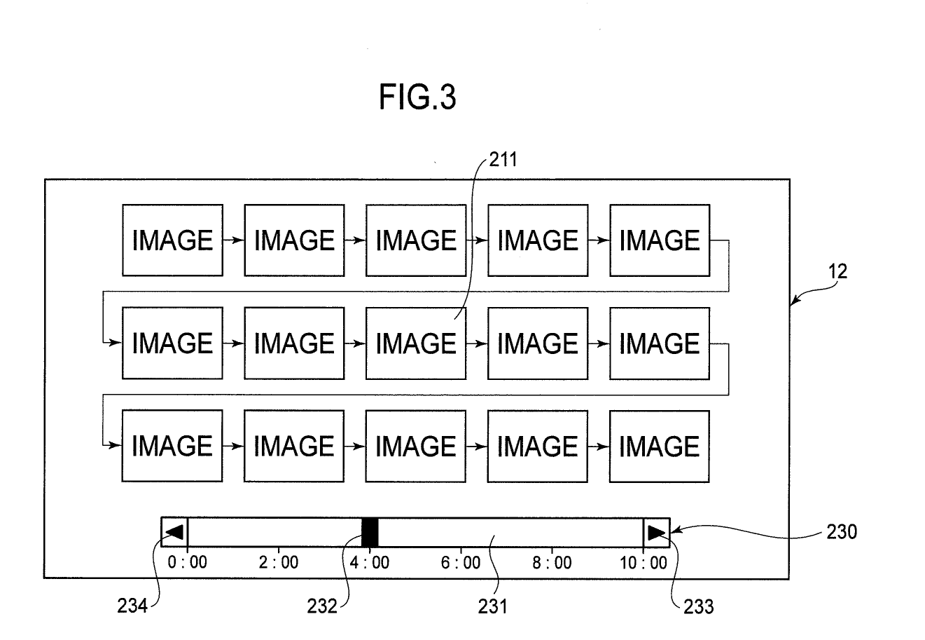

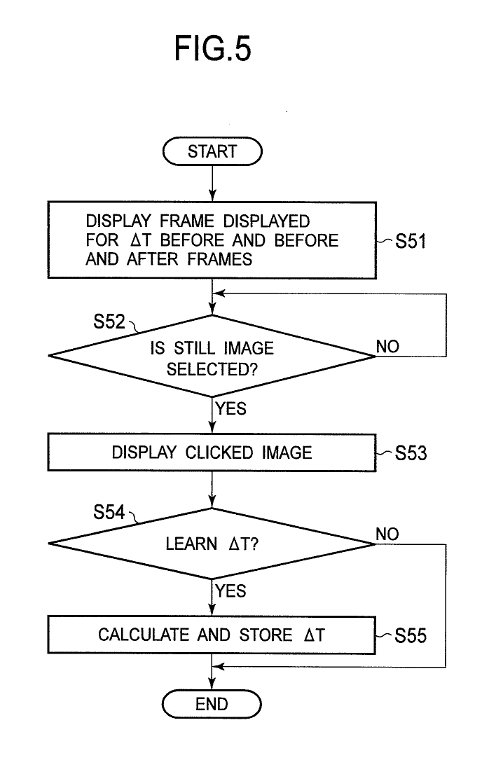

The moving image stopping process is described with reference to FIGS. 3-5. The moving image stopping process is executed when a user operates the play/pause button 221.

In step S51, the control unit 11 displays a target image and fourteen still images which are created by reducing in size the fifteen still images of fifteen frames on the display 12. The target image is a still image of the frame displayed at a time lag ΔT prior to the moment that the user operates the play/pause button 221 to stop the reproduction of a moving image while watching the moving image. The fourteen still images comprise seven still images of the seven frames which immediately precede the frame of the target image, and the other seven still images made from the seven frames which immediately follow the frame of the target image.

This results in a greater chance of the target image being displayed for later selection, despite the user's delay in stopping the moving image.

In step S52, it is judged whether the user has selected a desired image (second still image) from the fifteen displayed images or not. The selection is made by the user clicking the desired image on the display 12 using the mouse 16. The user may therefore find a desired image even if his/her actual time lag differs from ΔT.

In the case a desired still image is not selected in step S52, step S52 is executed again. In the case it is selected, the process goes to step S53.

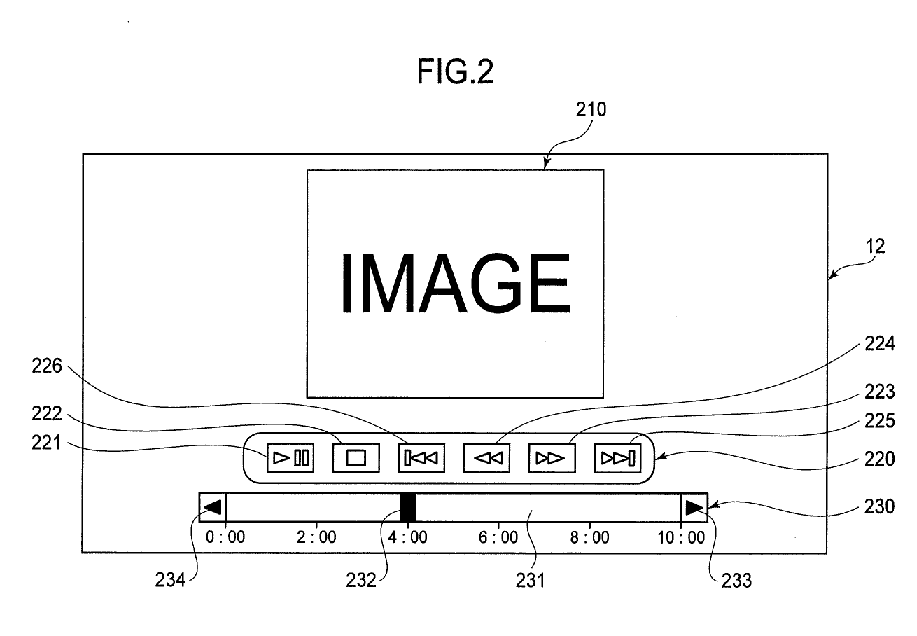

In step S53, the selected still image is enlarged and displayed on the display 12 as illustrated in FIG. 2. This allows the user to observe the selected still image, i.e., the target image, in detail.

In step S54, it is determined whether the control unit 11 learns the unique time lag ΔTu or not by determining whether the user has operated the learning button 17. In the case the user has operated the learning button 17, the process goes to step S55. In the case the user has not operated it, the moving image stopping process ends.

In step S55, the control unit 11 calculates the number of frames between the frame selected by the user and the frame displayed at the moment of operating the play/pause button 221, and inputs this frame number into the database as the user-specific time lag ΔTu. After that, the control unit 11 substitutes the time lag ΔT by the unique time lag ΔTu so that the time lag ΔT has been updated, i.e., learned. Then the moving image stopping process ends.

According to the first embodiment, a user can observe a desired still image in detail even if the time lag ΔT differs from the actual time lag of a user. The unique time lag ΔTu may be input into the database when a user desires by operation of the learning button 17. Moreover, the picture reproducer 10 can improve its accuracy in identifying the target image by this adjustment of the time lag ΔT.

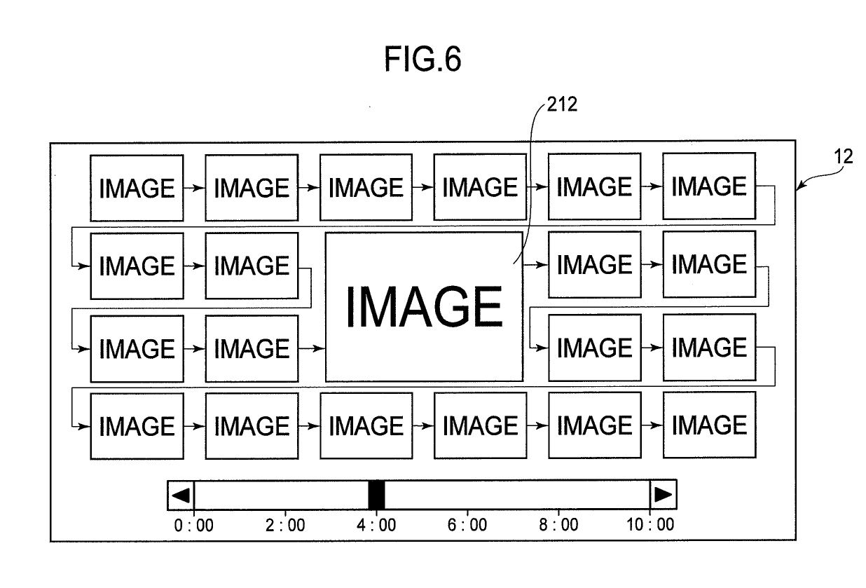

The second embodiment is described below with reference to FIG. 6. Descriptions of the constructions similar to the first embodiment are omitted.

The control device 11 stops the reproduction of a moving image by executing a moving image stopping process when the user operates the play/pause button 221 during the reproduction of a moving image. The control unit 11 displays a second target image 212 and twenty still images which are created by reducing in size the twenty-one still images of twenty-one frames on the display 12. The second target image 212 is a still image of the frame rewound by the time lag ΔT from the frame displayed at the moment that the user intended to operate the play/pause button 221. In other words, the frame of the second target image 212 is offset by the time lag ΔT from the frame displayed at the moment that the user intended to operate the play/pause button 221. The twenty still images comprise ten still images of the ten frames which immediately precede the frame of the second target image 212, and the other ten still images of the ten frames which immediately follow the frame of the second target image 212. The twenty-one still images are lined in ascending sequence of chronological order. The second target image 212 has a display area about four times larger than the other twenty still images, and is displayed in the center of the twenty-one still images.

According to the second embodiment, a user may observe the desired still image, i.e., the target image, in detail.

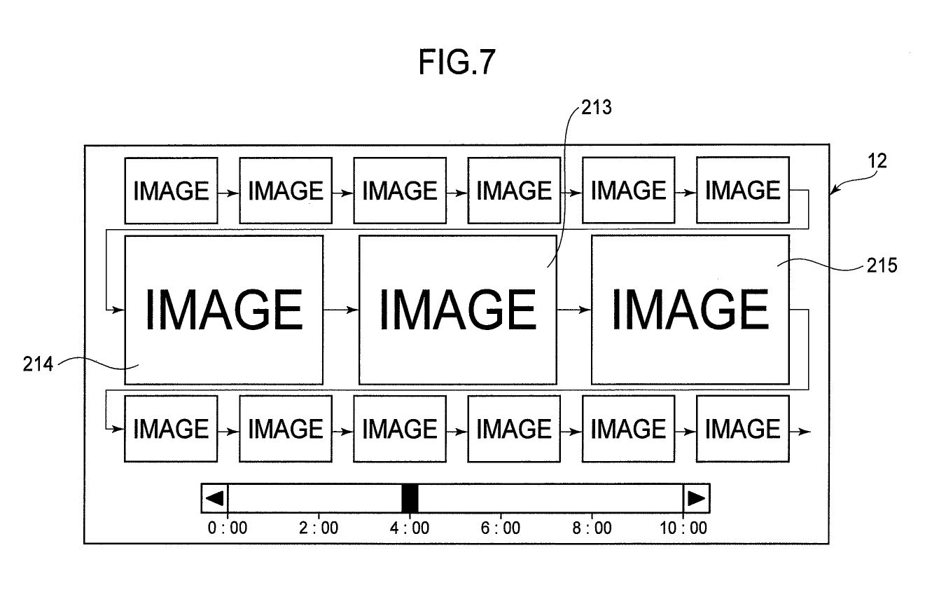

The third embodiment is described below with reference to FIG. 7. The descriptions of the constructions similar to the first and second embodiments are omitted.

The control device 11 stops the reproduction of a moving image by executing a moving image stopping process, when the user operates the play/pause button 221 during the reproduction of a moving image. The control unit 11 displays a third target image 213, a previous still image 214, an subsequent still image 215, and twelve still images which are created by reducing in size the fifteen still images of fifteen frames on the display 12. The third target image 213 is a still image of the frame rewound by the time lag ΔT from the frame displayed at the moment that the user intended to operate the play/pause button 221. In other words, the frame of the third target image 213 is offset by the time lag ΔT from the frame displayed at the moment that the user intended to operate the play/pause button 221. The previous still image 214 is a still image of the frame which immediately precedes the frame of the third target image 213. The subsequent still image 215 is a still image of the frame which immediately follows the frame of the third target image 213. The twelve still images comprise the six still images made by reducing in size six images of the six frames which immediately precede the frame of the previous still image 214, and the other 6 still images are made by reducing in size the six images of the six frames which immediately follow the frame of the subsequent still image 215.

The fifteen still images are ordered in ascending chronological order. The previous still image 214 and the subsequent still image 215 which immediately precede and follow the third target image 213, and the third target image 213 are displayed in the center of the fifteen still images. The display areas of the third target image 213, the previous still image 214, and the subsequent still image 215 are the same. The display areas of the twelve still images are same. The display areas of the third target image 213, the previous still image 214, and the subsequent still image 215 are larger than the display areas of twelve still images.

According to the third embodiment, a user may observe the desired still image, i.e. the target image and the still images which immediately precede and follow the target image in detail.

Note that a user may select the user name from registered user names displayed on the display 12 by mouse 16 without inputting his/her user name in the login process.

The still images may be displayed on the display 12 every plurality of frames, every second, or every plurality of seconds.

The time lag ΔT and the unique time lag ΔT may be other than frame numbers, such as a time period from the moment that a user operates the play/pause button 221 to the moment reproduction of a moving image is stopped. The average time lag ΔT could also be other than a frame number, such as an average time period which is calculated by averaging the time periods from the moment that a user operates the play/pause button 221 to the moment the reproduction of a moving image is stopped.

In step S43 of the identifying process, the time lag ΔT may be substituted by 0, or an average of all of the unique time lags ΔTu stored in the user database.

In step S54 of the moving image stopping process, the dialog which is provided for asking users whether the picture reproducer 10 learns the unique time lag ΔTu or not may be displayed on the display 12, and a user may be select whether learning or not by the keyboard 15 or the mouse 16.

In step S55 of the moving image stopping process, the memory 13 may store the past unique time lags ΔTu; the new unique time lag ΔTu may be calculated by averaging the stored past unique time lags ΔTu and the present calculated unique time lag ΔTu. This improves the accuracy of the unique time lag ΔTu.

The still images may be also be ordered in descending sequence of chronological order.

The picture reproducer 10 in accordance with the present invention may display still images successively. A user can easily select the desired still images from the plurality of the still images.

Although the embodiment of the present invention has been described herein with reference to the accompanying drawings, obviously many modifications and changes may be made by those skilled in the art without departing from the scope of the invention.

The present disclosure relates to subject matter contained in Japanese Patent Application No. 2007-304383 (filed on Nov. 26, 2007), which is expressly incorporated herein, by reference, in its entirety.

1. A picture reproducer comprising:
a display that successively displays a plurality of images;
a first image-selecting device that selects a first still image from a plurality of images displayed on said display;
a second image-selecting device that selects a second still image from a plurality of images displayed on said display;
an offset-detecting device that detects the offset between the first still image and the second still image; and
a memory that stores the offset;
said offset-detecting device updating the offset stored in said memory every time the offset is detected;
said display displaying a target still image which is offset from another still image by the updated offset, when the another still image is selected.

2. The picture reproducer according to claim 1, wherein said first and second image-selecting devices select the first and second still images in prior to the selection of another still image.

3. The picture reproducer according to claim 1, wherein said display displays a moving image which is recorded by a user, and said image-selecting device selects the first still image and the second still image from the moving image displayed on said display.

4. The picture reproducer according to claim 3, wherein the offset is the frame number of an image.

5. The picture reproducer according to claim 3, wherein said display simultaneously displays the target still image and the preceding and following images which were recorded before and after the target still image.

6. The picture reproducer according to claim 5, wherein said display displays the target still image at a size larger than the other images.

7. The picture reproducer according to claim 5, wherein said display displays the target still image and the preceding and following images in their chronological photographed order.

8. The picture reproducer according to claim 6, wherein said display displays the target still image and the preceding and following images which were recorded immediately before and immediately after the target still image, at a size larger than the other images.

9. The picture reproducer according to claim 1, wherein said offset-detecting device detects the offsets for each first still image and second still image selected and calculates the mean of these offsets, said memory stores the new mean offset, said offset-detecting device updates the new mean offset stored in said memory every time the new mean offset is calculated, and said display displays a target still image offset from the another still image by the new mean offset.

10. The picture reproducer according to claim 9 comprising a user-identifying device that identifies the users of said picture reproducer, wherein said memory stores the new mean offset associated with a user who is identified by said user-identifying device, and said display displays a target still image offset from the another still image by the new mean offset which is associated with the current user of said picture reproducer.

11. The picture reproducer according to claim 1, wherein the offset is a time interval.
